(19) United States
(12) Patent Application Publication
(10) Pub. No.: US 2017/0203416 A1
(43) Pub. Date: Jul. 20, 2017

(54) Direction controlling wrench tool

(71) Applicant: Jim LAI, Changua City, Taiwan (CN)

(72) Inventor: Jim Lai, CHANGHUA CITY (TW)

(21) Appl. No.: 15/030,863

(22) PCT Filed: Sep. 16, 2014
(86) PCT No.: PCT/CN2014/086619

§ 371 Date: Apr. 20, 2016

(51) Int. Cl. B25B 13/46

(52) U.S. Cl. CPC B25B 13/466

(57) ABSTRACT

A direction controlling wrench tool includes a head having a through hole with a driving member received therein, and a recess is defined in the inner periphery of the through hole. Two disks are respectively mounted to two sides of the driving member and are biased by two springs respectively. The driving member has first teeth and second teeth respectively defined in two opposite sides thereof. The first teeth and the second teeth extend toward two opposite directions. The two disks are respectively and selectively engaged with or disengaged from the first teeth and the second teeth of the driving member. A control unit is located in a reception hole in the recess and controls either one of the first and second disks to be engaged with/disengaged from the first/second teeth of the driving member to change the operational direction of the wrench.

### BACKGROUND OF THE INVENTION

1. Fields of the Invention

The present invention relates to a direction controlling wrench tool, and more particularly, to a control unit to control one of the two disks to be engaged with the driving member to control the operational direction of the wrench.

2. Descriptions of Related Art

The conventional ratchet wrench know to application is disclosed in Taiwan Patent Publication No. M465243and comprises a head with a through hole, and a recess is defined in the inner periphery of the through hole. A driving member is rotatably received in the through hole, and a pawl is located in the recess so as to be engaged with the driving member. The pawl includes teeth defined in each of two ends thereof, when either one end is engaged with the driving member, the rear side of the pawl contacts against the inner periphery of the recess so as to output high torque without shifting in the recess. The conventional ratchet wrench eliminates possibility of damage of the teeth of the driving member.

However, during operation of the conventional ratchet wrench, the teeth of the pawl move over the teeth of the driving member so that wearing happens to the teeth of the driving member. When the teeth of the driving member worn out, the driving member cannot bear high torque. Besides, only limited number of teeth are formed in each of the two ends of the pawl, and this also restricts the output of the torque. Furthermore, the tolerance of each teeth of the driving member and the pawl has to be controlled precisely such that the teeth of the pawl are engaged with the teeth of the driving member as desired. The cost of the manufacturing processes is therefore increased.

The present invention intends to provide a direction controlling wrench tool to eliminate the shortcomings mentioned above.

### SUMMARY OF THE INVENTION

The present invention relates to a direction controlling wrench tool and comprises a head having a through hole and a recess is defined in the inner periphery of the through hole. A driving member, a first disk, a second disk, a first spring and a second spring are located in the through hole. The driving member has a first toothed portion and a second toothed portion respectively defined in two opposite sides thereof The first toothed portion includes first teeth, and the second toothed portion includes second teeth. The first teeth and the second teeth extend toward two opposite directions. The first disk is selectively engaged with or disengaged from the first teeth of the driving member. The second disk is selectively engaged with or disengaged from the second teeth of the driving member. The first spring is biased between the first disk and the head, and the second spring is biased between the second disk and the head.

A control unit has a first end located in the recess and a second end located in the through hole so as to selectively shift the first disk to be engaged with or disengaged from the first teeth of the driving member, or to selectively shift the second disk to be engaged with or disengaged from the second teeth of the driving member. When the first disk is engaged with/disengaged from the first teeth of the driving member, the second disk is disengaged from/engaged with the second teeth of the driving member.

Preferably, the control unit includes a control member, a resilient member and a bead. The control member has a positioning portion, a first shifting member and a second shifting member, wherein the positioning portion is located in the recess, and the first and second shifting members are located in the through hole and spaced from each other. The first and second shifting members are respectively mounted to the first and second disks, the first shifting member is located between the first disk and the first toothed portion, and the second shifting member is located between the second disk and the second toothed portion. A reception hole is defined in the inner periphery of the recess, the resilient member is biased between the inner end of the reception hole and the bead which is partially protrudes into the through hole. The positioning portion includes multiple positioning notches, and the bead is engaged with one of the positioning notches.

Preferably, each of the first and second disks includes a first/second base disk. Multiple first engaging teeth are co-axially formed in the first base disk, and multiple second engaging teeth are co-axially formed in the second base disk. The first engaging teeth are engaged with the first toothed portion. The second engaging teeth are engaged with the second toothed portion. The first disk has first protrusions extending radially and outward therefrom, and the second disk includes second protrusions extending radially and outward there from.

Preferably, the first and second shifting members each are a ring-shaped member and are respectively mounted to outside of the first and second engaging teeth and are in contact with the first and second protrusions. The shape of the through hole is complementary to the shape of each of the first and second base disks which are movably received in the through hole.

Preferably, the diameter of each of the first and second springs increase from one end close to the first/second disk toward the other end close to the head.

Preferably, the driving member has a mounting hole which is adapted to be mounted to a socket.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the direction controlling wrench tool of the present invention;

FIG. 2 is a perspective view to show the direction controlling wrench tool of the present invention;

FIG. 3 shows that the two disks are respectively engaged with the first and second toothed portions of the driving member of the present invention;

FIG. 4 shows that the first disk is engaged with the first toothed portion of the driving member, and the second disk is disengaged from the second toothed portion of the driving member;

FIG. 5 is an enlarged view of the a portion of the status in FIG. 4;

FIG. 6 shows that the second disk is engaged with the second toothed portion of the driving member, and the first disk is disengaged from the first toothed portion of the driving member, and

FIG. 7 is an enlarged view of a portion of the status in FIG. 6.

### DETAILED DESCRIPTION OF THE PREFERRED EMBODIMENT

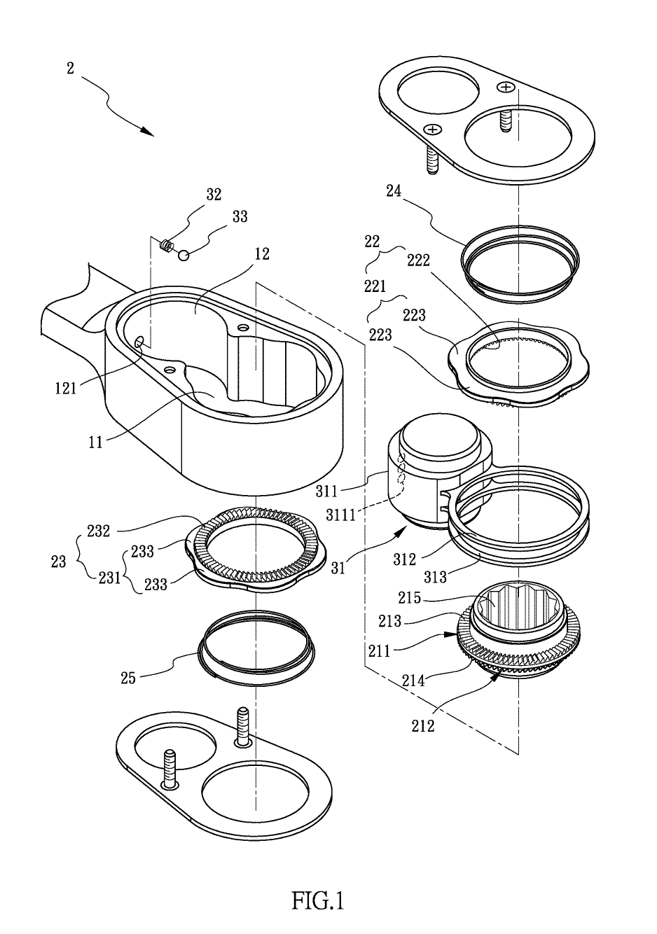

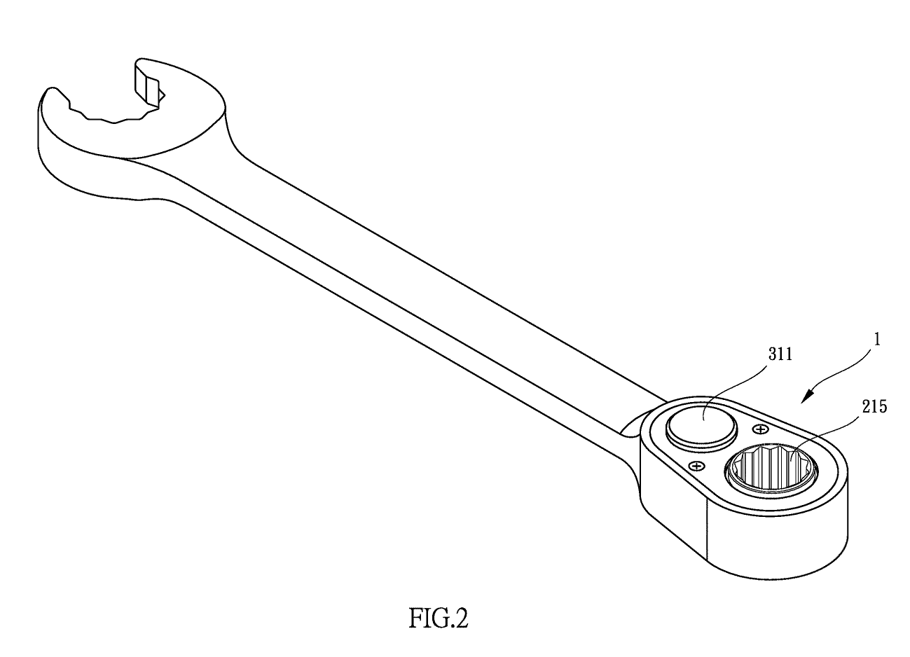

Referring to FIGS. 1 and 2, the direction controlling wrench tool of the present invention comprises a head 1 having a through hole 11 defined there through, and a recess 12 is defined in the inner periphery of the through hole 11 and communicates with the through hole 11. An engaging unit 2 is located in the through hole 11 and has a driving member 21, a first disk 22, a second disk 23, a first spring 24 and a second spring 25. The driving member 21 has a first toothed portion 211 and a second toothed portion 212 respectively defined in two opposite sides thereof The first toothed portion 211 includes multiple first teeth 213, and the second toothed portion 212 including multiple second teeth 214, wherein the first teeth 213 and the second teeth 214 extend toward two opposite directions. In this embodiment, the first teeth 213 are designed for clockwise use of the wrench tool, and the second teeth 214 are designed for counter clockwise use of the wrench tool. The first disk 22 is selectively engaged with or disengaged from the first teeth 213 of the driving member 21, and the second disk 23 is selectively engaged with or disengaged from the second teeth 214 of the driving member 21. The first spring 24 is biased between the first disk 22 and the head 1, and the second spring 25 is biased between the second disk 23 and the head 1. When the first disk 22 is rotated relative to the first teeth 213 of the driving member 21 and is disengaged from the first teeth 213 of the driving member 21, the first spring 24 is compressed and stores energy which is used to push the first disk 22 toward the driving member 21 again. The relationship between the second disk 23 and the second spring 25 are the same as that of the first disk 22 and the first spring 24.

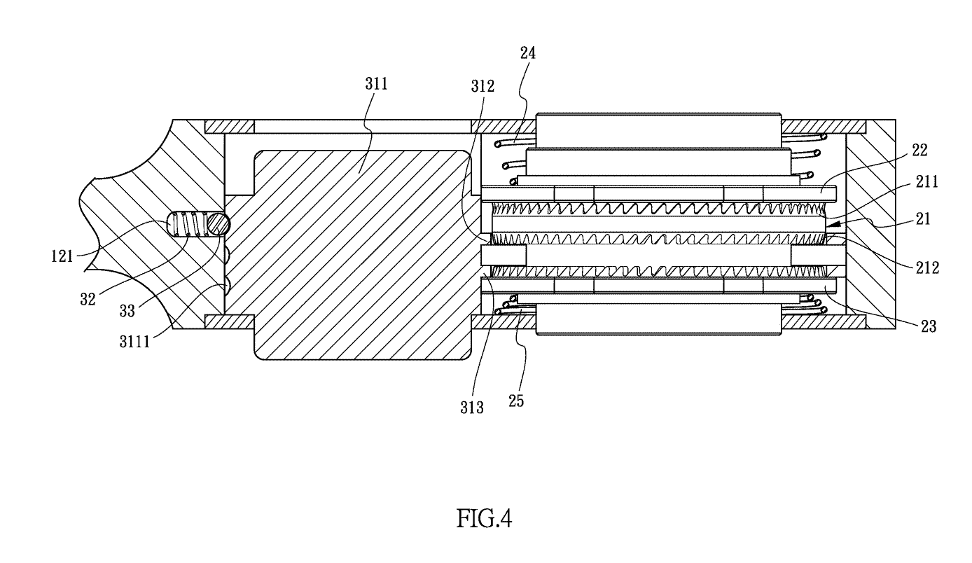

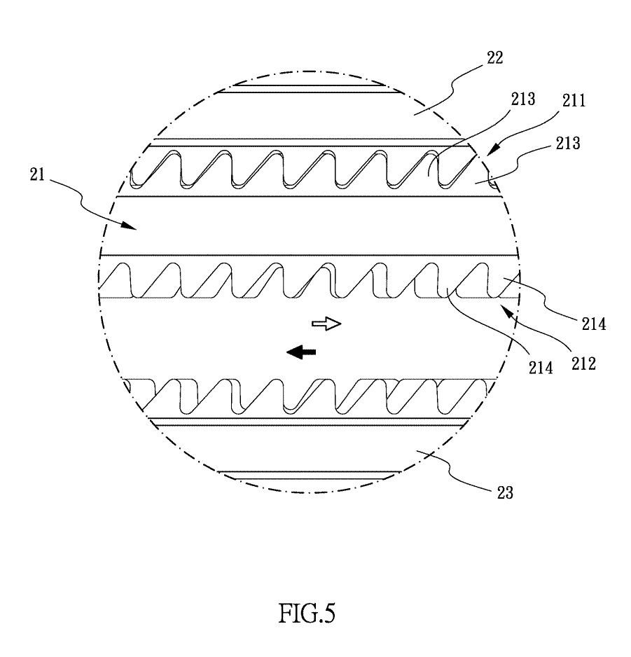

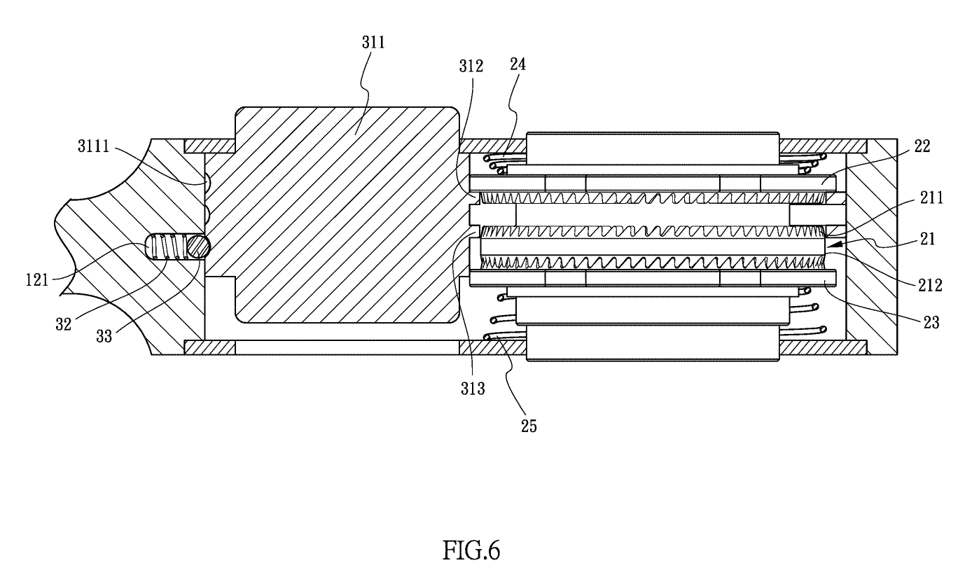

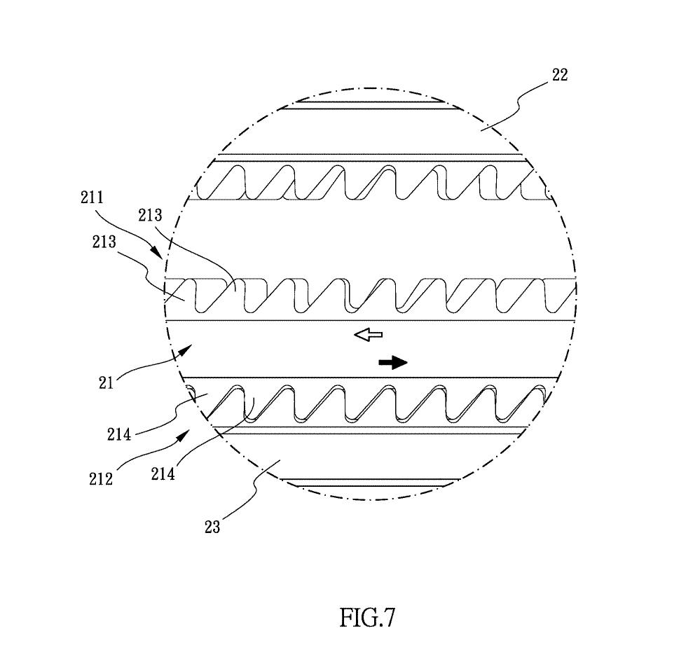

Because the first and second teeth 213, 214 extend toward different directions, as shown in FIGS. 4 and 5, when the first disk 22 is engaged with the first teeth 213 of the driving member 21, and the second disk 23 is disengaged from the second teeth 214 of the driving member 21, the driving member 21 output torque in the direction that is shown by the hollow arrow, and the driving member 21 is freely rotated in the direction that is shown by the solid arrow. On the contrary, as shown in FIGS. 6 and 7, when the second disk 23 is engaged with the second teeth 214 of the driving member 21, and the first disk 22 is disengaged from the first teeth 213 of the driving member 21, the driving member 21 output torque in the direction that is shown by the hollow arrow, and the driving member 21 is freely rotated in the direction that is shown by the solid arrow.

By operating the control unit 3 to control the first disk 22 to be engaged with the first teeth 213 of the driving member 21, and the second disk 23 to be disengaged from the second teeth 214 of the driving member 21, or to control the second disk 23 to be engaged with the second teeth 214 of the driving member 21, and the first disk 22 to be disengaged from the first teeth 213 of the driving member 21, the user can switch the operational direction of the wrench tool as needed without dis-mounting the wrench tool and re-mounting it again.

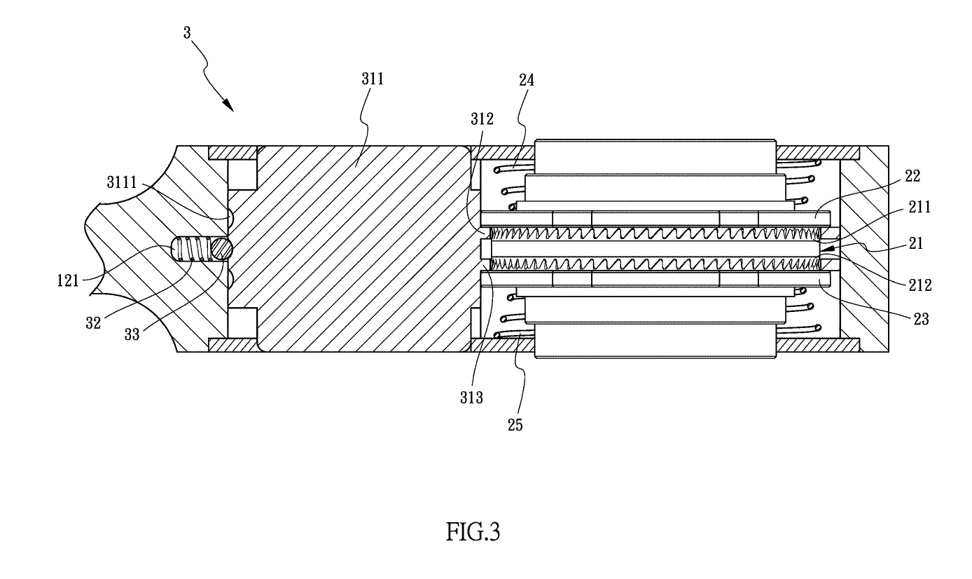

As shown in FIGS. 1, 3 and 4, the control unit 3 includes a control member 31, a resilient member 32 and a bead 33. The control member 31 has a positioning portion 311, a first shifting member 312 and a second shifting member 313. The positioning portion 311 is located in the recess 12, and the first and second shifting members 312, 313 extend from the positioning member 311 and are located in the through hole 11 and spaced from each other. The first and second shifting members 312, 313 are respectively mounted to the first and second disks 22, 23. The first shifting member 312 is located between the first disk 22 and the first toothed portion 211, and the second shifting member 313 is located between the second disk 23 and the second toothed portion 212. A reception hole 121 is defined in the inner periphery of the recess 12. The resilient member 32 is biased between an inner end of the reception hole 121 and the bead 33 which is partially protrudes into the through hole 11. The positioning portion 311 includes three positioning notches 3111, and the bead 33 is engaged with one of the positioning notches 3111. As shown in FIGS. 2 to 4, the positioning member 311 is a button-like member, when the positioning member 311 is pushed, the first and second shifting members 312, 313 are shifted. As shown in FIG. 3, the bead 33 is engaged with the middle positioning botch 3111, and the first and second disks 22, 23 are respectively engaged with the first and second toothed portions 211, 212, and the driving member 21 cannot be rotated.

By pushing the positioning member 311, the bead 33 is engaged with the upper positioning botch 3111, the second shifting member 313 pushes the second disk 23 to be disengaged from the second toothed portion 212, and the first disk 22 is still engaged with the first toothed portion 211. As shown in FIGS. 4 and 5, the direction (counter clockwise) that is represented by the hollow arrow outputs torque, and the direction (clockwise) that is represented by the solid arrow allows the driving member 21 to be freely rotated. On the contrary, as shown in FIGS. 6 and 7, when the positioning member 311 is pushed from the other direction, the first shifting member 312 pushes the first disk 22 to be disengaged from the first toothed portion 211, and the second disk 23 is still engaged with the second toothed portion 212. As shown in FIG. 6, the direction (clockwise) that is represented by the hollow arrow outputs torque, and the direction (counter clockwise) that is represented by the solid arrow allows the driving member 21 to be freely rotated.

Each of the first and second disks 22, 23 includes a first/second base disk 221/231, the first engaging teeth 222 are co-axially formed in the first base disk 221, and the second engaging teeth 232 are co-axially formed in the second base disk 231. The first engaging teeth 222 are engaged with the first toothed portion 211, and the second engaging teeth 232 are engaged with the second toothed portion 212. The first disk 22 has first protrusions 223 extending radially and outward there from, and the second disk 23 includes second protrusions 233 extending radially and outward there from. The first and second shifting members 312, 313 each are a ring-shaped member and are respectively mounted to outside of the first and second engaging teeth 222, 232 and are in contact with the first and second protrusions 223, 233. The shape of the through hole 11 is complementary to the shape of each of the first and second base disks 221, 231 which are movably received in the through hole 11. The diameter of each of the first and second springs 24, 25 gradually increases from one end close to the first/second disk 22/23 toward the other end close to the head 1. The driving member 21 has a mounting hole 215 which is adapted to be mounted to a socket.

While we have shown and described the embodiment in accordance with the present invention, it should be clear to those skilled in the art that further embodiments may be made without departing from the scope of the present invention.

What is claimed is:

1. A direction controlling wrench tool comprising:
a head having a through hole defined therethrough, a recess defined in an inner periphery of the through hole and communicating with the through hole;
an engaging unit located in the through hole and having a driving member, a first disk, a second disk, a first spring and a second spring, the driving member having a first toothed portion and a second toothed portion respectively defined in two opposite sides thereof, the first toothed portion including first teeth, the second toothed portion including second teeth, the first teeth and the second teeth extending toward two opposite directions, the first disk selectively engaged with or disengaged from the first teeth of the driving member, the second disk selectively engaged with or disengaged from the second teeth of the driving member, the first spring biased between the first disk and the head, the second spring biased between the second disk and the head, and
a control unit having a first end located in the recess and a second end located in the through hole so as to selectively shift the first disk to be engaged with or disengaged from the first teeth of the driving member, or to selectively shift the second disk to be engaged with or disengaged from the second teeth of the driving member, when the first disk is engaged with/disengaged from the first teeth of the driving member, the second disk is disengaged from/engaged with the second teeth of the driving member.

2. The direction controlling wrench tool as claimed in claim 1, wherein the control unit includes a control member, a resilient member and a bead, the control member has a positioning portion, a first shifting member and a second shifting member, the positioning portion is located in the recess, the first and second shifting members are located in the through hole and spaced from each other, the first and second shifting members are respectively mounted to the first and second disks, the first shifting member is located between the first disk and the first toothed portion, the second shifting member is located between the second disk and the second toothed portion, a reception hole is defined in an inner periphery of the recess, the resilient member is biased between an inner end of the reception hole and the bead which is partially protrudes into the through hole, the positioning portion includes multiple positioning notches, the bead is engaged with one of the positioning notches.

3. The direction controlling wrench tool as claimed in claim 2, wherein each of the first and second disks includes a first/second base disk, first engaging teeth are co-axially formed in the first base disk, second engaging teeth are co-axially formed in the second base disk, the first engaging teeth are engaged with the first toothed portion, the second engaging teeth are engaged with the second toothed portion, the first disk has first protrusions extending radially and outward there from, the second disk includes second protrusions extending radially and outward there from.

4. The direction controlling wrench tool as claimed in claim 3, wherein the first and second shifting members each are a ring-shaped member and are respectively mounted to outside of the first and second engaging teeth and are in contact with the first and second protrusions, a shape of the through hole is complementary to a shape of each of the first and second base disks which are movably received in the through hole.

5. The direction controlling wrench tool as claimed in claim 1, wherein a diameter of each of the first and second springs increase from one end close to the first/second disk toward the other end close to the head.

6. The direction controlling wrench tool as claimed in claim 1, wherein the driving member has a mounting hole which is adapted to be mounted to a socket.
